(19) United States
(12) Patent Application Publication
(10) Pub. No.: US 2016/0239771 A1
(43) Pub. Date: Aug. 18, 2016

(54) MONITORING ECOMMERCE TRANSACTIONS USING TRANSACTION METRICS STATISTICS FOR DIFFERENT COMBINATIONS OF TRANSACTION ATTRIBUTES AND VALUES

(71) Applicant: CA, Inc., New York, NY (US)

(72) Inventors: Sreenivas GUKAL, Santa Clara, CA (US); Suresh YANAMADALA, Redwood City, CA (US); Sanjay VYAS, Fremont, CA (US); Rammohan VARADARAJAN, Cupertino, CA (US)

(73) Assignee: CA, Inc., New York, NY (US)

(21) Appl. No.: 14/620,616

(22) Filed: Feb. 12, 2015

(51) Int. Cl. G06Q 10/06

(52) U.S. Cl. CPC G06Q 10/0635

(57) ABSTRACT

A method performed by an eCommerce risk assessment system includes receiving eCommerce transaction reports, each containing transaction metrics and transaction attributes having values. A statistic is separately generated for each different type of the transaction metrics based on the values of the transaction attributes. One type of the transaction metrics is selected for analysis. For each combination of a different type of the transaction attributes and a different value among the values occurring for the type of the transaction attribute, a transaction metric statistic is generated for the selected type of the transaction metrics having the combination of the type of the transaction attribute and the value. An analytical model of the eCommerce transactions is trained based on the values of the transaction attributes for the transaction metric statistics. Risk scores are output from the analytical model based on content of eCommerce transactions input to the analytical model.

### BACKGROUND

The present disclosure relates to financial transaction processing systems.

Financial transactions relating to purchasing goods and services are predominately paid for using credit accounts and debit accounts that an account owner accesses through associated credit cards and debit cards. Financial transaction processing systems provide verification processes that allow merchants to verify that account information is valid and the account owner has sufficient credit or debit funds to cover the purchase.

When a purchaser is located at the merchant's facility, the merchant is responsible for authenticating that the purchaser is the account owner by, for example, comparing the purchaser's signature to a existing signature on the card, examining a picture ID of the purchaser, or providing a password.

For purchases made through a merchant's website and other electronic commerce (“eCommerce”) transactions (known as a card-not-present transactions (CNP)), financial transaction processing systems can use eCommerce authentication processes that challenge the purchaser to provide a security code that is used to authenticate that the purchaser is the account owner or is otherwise authorized by the account owner. The security code may be a password, personal identification number (PIN), or other information known to the account owner such as a onetime password received through e-mail, text message, etc. Purchasers can find eCommerce authentication processes undesirable due to the need to remember security codes and the requirement to successfully complete additional process steps for purchases. Merchants can find eCommerce authentication processes undesirable because of the fees charged for use of such processes and lost sales due to purchasers abandoning transactions during the eCommerce authentication processes.

### SUMMARY

Some embodiments of the present disclosure are directed to a method performed by an eCommerce risk assessment computer system. The method includes receiving eCommerce transaction reports, where each of the reports contains transaction metrics and transaction attributes having values. A statistic is separately generated for each different type of the transaction metrics across the reports based on the values of the transaction attributes. One of the statistics, for one type of the transaction metrics, that has changed at least a threshold amount between two time intervals is identified. The one type of the transaction metrics is selected for analysis. For each combination of a different type of the transaction attributes and a different value among the values occurring for the type of the transaction attribute, a transaction metric statistic is generated for the selected type of the transaction metrics from the reports having the combination of the type of the transaction attribute and the value, and a counter is incremented that tracks a number of occurrences of the combination of the type of the transaction attribute and the value among the reports. An analytical model of the eCommerce transactions is trained based on the values of the transaction attributes for the transaction metric statistics for the selected type of the transaction metrics and based on the counters that track a number of occurrences of the combination of the type of the transaction attribute and the value among the reports. Risk scores are output from the analytical model based on content of eCommerce transactions that are input to the analytical model.

Other computer program products, methods, and systems according to embodiments of the present disclosure will be or become apparent to one with skill in the art upon review of the following drawings and detailed description. It is intended that all such additional computer program products, methods, and systems be included within this description, be within the scope of the present disclosure, and be protected by the accompanying claims. Moreover, it is intended that all embodiments disclosed herein can be implemented separately or combined in any way and/or combination.

### BRIEF DESCRIPTION OF THE DRAWINGS

Aspects of the present disclosure are illustrated by way of example and are not limited by the accompanying drawings. In the drawings:

FIG. 1 is a block diagram of a financial transaction processing system that includes an authentication gateway node that controls which eCommerce authentication requests are selected for authentication by an authentication node, in accordance with some embodiments;

FIG. 2 is block diagram illustrating further details of the financial transaction processing system of FIG. 1 that uses an analytical model of content of eCommerce transaction reports to control selection of eCommerce authentication requests for authentication in accordance with some embodiments;

FIGS. 3 and 4 are flowcharts of operations that may be performed by the authentication gateway node of FIGS. 1 and 2 to train the analytical model and to generate risk scores that control selection of eCommerce authentication requests for authentication or by other eCommerce risk assessment computer systems in accordance with some embodiments;

FIG. 5 is a block diagram of an eCommerce risk assessment computer system that may be incorporated into various components of the system of FIGS. 1-4, in accordance with some embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

Some embodiments of the present disclosure are directed to a financial transaction processing system that includes an authentication gateway node which includes an analytical model that models characteristics of eCommerce transactions (e.g., credit card transaction, debit card transaction, etc.) that were later determined to be fraudulent or associated with another defined risk factor. The authentication gateway node uses the analytical model to generate risk scores based on similarities between the model characteristics of the eCommerce transactions and presently pending eCommerce transactions. Based on the risk scores the authentication gateway node selectively initiates authentication processes to authenticate a person who is associated with the respective eCommerce transactions (e.g., request password, personal identification number, electronic security token, or other secret information known to the account owner) and/or selectively notifies a finance issuer node (e.g., credit/debit card bank server) that privileges with an account associated with the eCommerce transaction should be halted/frozen (e.g., cancel card access) or otherwise modified. These and other related embodiments may thereby enable identification of accounts that are at-risk of fraud or other defined risk before those accounts are compromised.

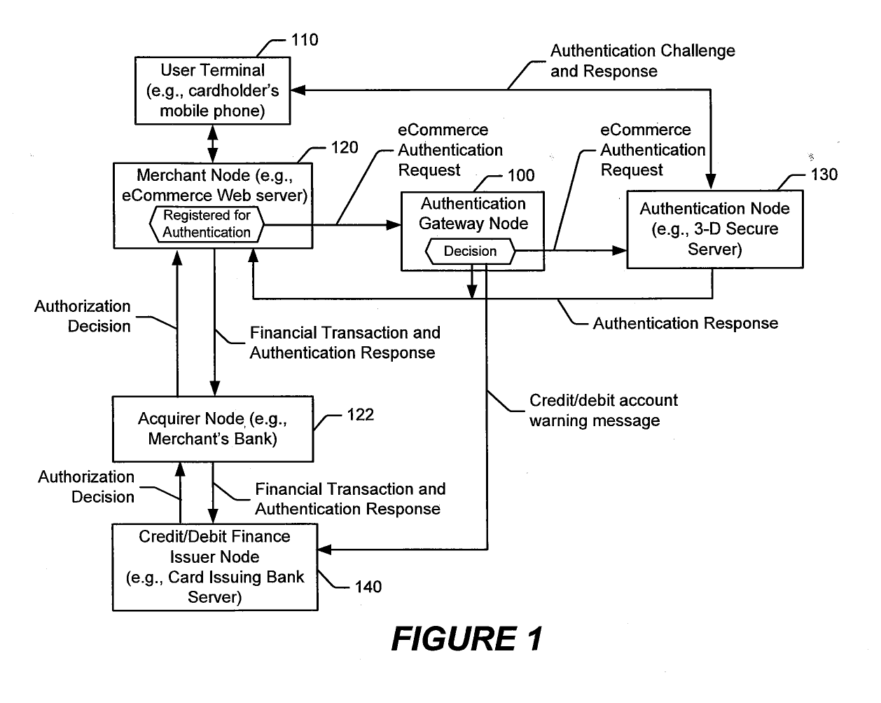

FIG. 1 is a block diagram of a financial transaction processing system that includes an authentication gateway node 100, e.g., an eCommerce risk assessment computer system, that controls which eCommerce authentication requests are authenticated by an authentication node 130 in accordance with some embodiments. Although some embodiments are described in the context of authenticating credit card and/or debit card transactions for purchases made through a merchant's node 120 (e.g., merchant's eCommerce Web server), the embodiments disclosed herein are not limited thereto and can be used with other types of authentication processes.

Referring to FIG. 1, a person who is purchasing an item (purchaser) operates a user terminal 110 to select items to be purchased, and provides (e.g., types, electronically scans, executes an application on the user terminal 100 that outputs, etc.) cardholder information that can include any one or more of: an account number (e.g., credit card number and/or debit card number); customer name; account verification information; cardholder's name; an expiration date for the card; a card verification value (CVV); the cardholder's home address; and the purchaser's shipping address. The cardholder information is communicated by the user terminal 110 to the merchant node 120. The user terminal 110 may be any electronic device that can communicate with a merchant node 120 including, but not limited to, a tablet computer, desktop computer, laptop computer, mobile phone, a point-of-sale merchant terminal, etc.

An application (e.g., on-line retailer application) executed by the user terminal 110 may be configured to communicate further information to the merchant node 120 that can include one or more of: a present geographic location of the purchaser's user terminal (latitude and longitude coordinates, regional identifiers, network addresses, etc); a user terminal identifier (network address of the user terminal, telephone number of the user terminal, and/or International Mobile Subscriber Identity of the user terminal); a user terminal manufacturer (values among list of defined manufacturers); a user terminal model (values among list of defined models); a Web browser type and version used by the user to initiate the eCommerce transaction (values among list of defined types and versions); user terminal processor type (values among list of defined types); user terminal communication type presently used for the eCommerce transaction (values among list of defined types of communication links, e.g., Verizon 4G LTE, Verizon 3G, AT&T 4G LTE, WIFI, cable modem, digital subscriber line, etc.); and user terminal operating system type and version (values among list of defined types).

Because of the prevalence of fraud occurring in eCommerce and other card-not-present financial transactions, where merchants cannot directly authenticate purchasers using picture IDs, electronic authentication processes have been introduced to authenticate purchasers. Electronic authentication processes can be performed by an authentication node 130 to attempt to confirm that the purchaser is an account owner or is otherwise authorized by the account owner.

A determination is made whether the card account is registered for use of electronic authentication processes. Registration may be explicit, such as when a credit/debit issuer node (e.g., card issuing bank) requests a cardholder to complete a defined process to enroll the cardholder account for the authentication service, or may be activated during a transaction, such as based on the card number being within a defined range authorized for the authentication service. Based on determining that the authentication process should be performed, the merchant node 120 generates an eCommerce transaction report, which may be an eCommerce authentication request, containing transaction attributes having values characterizing the pending eCommerce transaction. Values of the transaction attributes can be generated based on the cardholder information received from the user terminal 100 and the merchant node 120, and may include transaction details, geo-location information, user terminal characteristics, and/or user account history information, etc and may include further sub-transaction attributes, such as the lettered sub-transaction attributes listed below. In accordance with some embodiments disclosed herein, the eCommerce transaction report may include any one or more of the following transaction attributes and corresponding example values (bracketed):
1) eCommerce Transaction Details
   a) Type (card present, card not present);
   b) account number (values among defined credit/debit card numbers);
   c) expiration date for the card (values among defined date ranges);
   d) verification value (CVV-card verification value);
   e) cardholder's name (alphabetic string);
   f) the cardholder's home address (alphanumeric string);
   g) the purchaser's shipping address (values among defined streets, cities, states, zip codes, countries);
   h) amount of the financial transaction (monetary number);
   i) time of transaction (values among defined time ranges);
   j) date of transaction (values among defined date ranges);
   k) a geographic location of the merchant node (values among defined streets, cities, states, zip codes, countries, or latitude and longitude coordinates, or network addresses, etc.);
2) Geo-Location Information
   a) present geographic location of the purchaser's user terminal (latitude and longitude coordinates, regional identifiers, network addresses, etc);
   b) past history of geographic locations of the purchaser's user terminal (latitude and longitude coordinates, regional identifiers, network addresses, etc);
3) User Terminal Characteristics (card-not-present transaction)
   a) user terminal identifier (network address of the user terminal, telephone number of the user terminal, and/or International Mobile Subscriber Identity of the user terminal);
   b) user terminal manufacturer (values among list of defined manufacturers);
   c) user terminal model (values among list of defined models);
   d) Web browser type and version used by the user to initiate the eCommerce transaction (values among list of defined types and versions);
   e) eCommerce application type and version (values among list of defined types and versions);
   f) user terminal processor type (values among list of defined types);
   g) user terminal communication type used for the eCommerce transaction (values among list of defined types of communication links, e.g., Verizon 4G LTE, Verizon 3G, AT&T 4G LTE, WIFI, cable modem, digital subscriber line, etc.);
   h) user terminal operating system type and version (values among list of defined types);
4) User account history
   a) account owner's home address change history;
   b) password change history;
   c) failed password entry history;
   d) new card issuance history.

Each of the above-listed transaction attributes have values which may be constrained to a defined set of values (e.g., defined types of Web browsers and associated version numbers, or geo-location information represented by closest city among defined cities) or may be unconstrained to any defined set of values (e.g., user terminal identifier, or geo-location information represented by latitude and longitude coordinates).

The identifier for the user terminal may uniquely identify the user terminal, such as by a telephone number of the user terminal and/or an International Mobile Subscriber Identity of the user terminal, which can be determined by the merchant node 120 or another system component and included in the eCommerce authentication request.

The identifier for the user terminal can be defined by a network address associated with the user terminal (e.g., IP address), such as the network address of a network access node (e.g., cable modem, DSL modem, wireless access point, etc), the intermediate routing address of an edge router, and/or another network address that sufficiently defines a group of network locations and/or geographic region from which a user terminal is communicating when performing an eCommerce transaction. The network address may thereby identify a plurality of different user terminals that communicate via the same network access node through the Internet or other data network (e.g., public/private network) with the merchant node 120.

The identifier for the user terminal may additionally or alternatively be a geographic region of the user terminal (e.g., GPS and/or network-assisted determination of location), a user terminal name (e.g., user defined name), a cookie or other information stored on the user terminal during account setup/maintenance with the issuer node and/or the merchant node.

Values of the user account history attributes may be generated by the merchant node 120 based on historical information maintained for the purchaser's account.

The merchant node 120 communicates the eCommerce transaction reports toward the authentication node 130 for authentication processing to authenticate the purchaser. These eCommerce transaction reports output by the merchant nodes 120 are also referred to as eCommerce authentication requests below for descriptive convenience of reference and without limitation. The merchant node 120 may communicate the eCommerce authentication requests using a software plug-in provided by a provider of the authentication node 130. Authentication of the purchaser can include determining whether the purchaser possesses secret information that should only be known to the account owner or another person who has been authorized by the account owner to make purchases using the account.

As will be explained in further detail below, an authentication gateway node 100 is disclosed herein that controls which eCommerce authentication requests from the merchant node 120 and other merchant nodes 120 cause authentication of purchasers. The authentication gateway node 100 may also generate a credit/debit account warning message which notifies a credit/debit finance issuer node 140 (e.g., card issuing bank server) that privileges with an account should be halted/frozen (e.g., cancel card) or otherwise modified.

The authentication gateway node 100 may intercept the eCommerce authentication requests from the merchant node 120 and determine whether authentication will be performed by the authentication node 130. The authentication gateway node 100 may, for example, selectively either route the eCommerce authentication request to the authentication node 130 for authentication or respond to the merchant node 120 without authentication by the authentication node 130, so that some eCommerce authentication requests bypass the authentication node 130. Alternatively, the authentication gateway node 100 may mark the eCommerce authentication requests to indicate whether they are to be authenticated by the authentication node 130 (e.g., all eCommerce authentication requests flow through the authentication node 130 but only some cause authentication). These and other operations by the authentication gateway node 100 are described in further detail below.

Pursuant to one type of authentication process, the authentication node 130 communicates an authentication challenge message to the user terminal 110 which requires the purchaser to enter a security code to complete the purchase. The entered security code is returned to the authentication node 130 in a response message. The security code may be a password, personal identification number (PIN), electronic security token, or other secret information known to the account owner. The authentication node 130 can compare the security code to an expected code, and apply one or more rules which may be defined by the card issuing bank (referred to more generally as the credit/debit finance issuer node below) to generate an authentication response (e.g., authentication response code) that indicates an outcome of the authentication process.

One type of authentication process is known as a 3-D Secure protocol that can be performed by the authentication node 130 operating as a 3-D Secure authentication server. The 3-D Secure protocol was developed by financial card associations, including Visa and MasterCard, and has become an industry standard. The protocol uses XML messages sent over secure socket layer (SSL) connections between user terminal 110 or other client authentication terminals and the authentication node 130, which can also be referred to as an access control server (ACS). The authentication challenge can be presented through the user terminal 110 to the purchaser within the same web browser window as an in-line session (referred to as an inframe authentication session) or can be presented in a separate window (e.g., pop-up window).

An advantage to merchants of using purchaser authentication is a reduction in “unauthorized transaction” chargebacks. A disadvantage to merchants is that they pay a software setup fee, monthly fee, and per-authentication fee for use of the 3-D Secure access control server provided by the authentication node 130. Moreover, 3-D Secure operation can be complicated and create transaction failures.

Some purchasers view the additional authentication steps as a nuisance or obstacle to completing transactions and/or they erroneously interpret the authentication challenge (e.g., pop-up window) as originating from a fraudulent phishing site/process, which can result in a substantial increase in transaction abandonment by the purchaser and lost revenue to merchants. Some 3-D Secure authentication processes require the purchaser to complete an authentication registration process for the cardholder's financial account, including agreeing to all terms and conditions presented by 3-D Secure, before the purchaser can proceed with a purchase. Purchasers who are unwilling to undertake the risk or inconvenience of registering their card during a purchase, are forced to abandon the transaction. Moreover, some user terminals, such as those having mobile web browsers, can lack features (e.g, support for window frames and/or pop-ups) necessary for proper operation of a 3-D Secure authentication process.

For these and other reasons, some embodiments disclosed herein are directed to the authentication gateway node 100 that processes eCommerce authentication requests through an analytical model 102 (e.g., non-linear analytical model) to generate risk scores. The authentication gateway node 100 then selectively provides the eCommerce authentication requests to the authentication node 130 based on the risk scores. The authentication gateway node 100 can be configured to operate on eCommerce authentication requests in-flight before being delivered to the authentication node 130, and control, based on the risk scores, which of the eCommerce authentication requests are processed by the authentication node 130 for authentication of purchasers and generation of authentication responses based on the outcomes of the authentication.

In one embodiment, only eCommerce authentication requests having risk scores that satisfy a defined rule are provided to the authentication node 130 for authentication processing and generation of the authentication responses based on the authentication processing, while other eCommerce authentication requests (having risk scores that do not satisfy the defined rule) bypass authentication processing by the authentication node 130. When bypassing authentication processing by the authentication node 130, the authentication gateway node 100 may generate an authentication response based on the risk score for the eCommerce authentication request (e.g., generate an authentication response indicating that the purchaser was properly authenticated) and communicate the authentication response to the merchant node 120 as if it had originated from the authentication node 130. When the authentication response is generated by the authentication gateway node 100, it may contain the same or similar content to an authentication response generated by the authentication node 130 so that the merchant node 120 is not aware that the authentication response was generated without authentication of the purchaser being performed by the authentication node 130.

When selectively providing the eCommerce authentication request to the authentication node 130, the authentication gateway node 100 may selectively mark the eCommerce authentication request to indicate whether authentication of the purchaser by the authentication node 130 is requested based on whether the risk score satisfies a defined rule. The authentication gateway node 130 then performs authentication processing (e.g., providing authentication challenges to purchasers) for only the eCommerce authentication requests that are marked for authentication. The authentication gateway node 130 can then generate the authentication responses based on a result of the authentication processing when performed, or based on the risk score when authentication processing is not performed.

In another embodiment, when selectively providing the eCommerce authentication request to the authentication node 130, the authentication gateway node 100 selectively routes the eCommerce authentication request to the authentication node 130 for authentication of the purchaser based on whether the risk score satisfies a defined rule. Accordingly, the authentication node 130 performs purchaser authentication processes for each eCommerce authentication request that it receives, however the authentication node 130 only receives eCommerce authentication requests having risk scores that the authentication gateway node 100 determined to satisfy a defined rule (e.g., having a risk score that exceeds a threshold level or alternatively that does not exceed a threshold level).

In another embodiment, the authentication node 130 can include some of the functionality described herein of the authentication gateway node 100. The authentication node 130 can receive all eCommerce authentication requests, but selectively generate an authentication challenge to the user equipment 110 (FIG. 1) to authenticate the purchaser only for eCommerce authentication requests having risk scores that satisfy a defined rule.

Depending upon the risk score, the authentication gateway node 100 may generate a credit/debit account warning message which notifies the credit/debit finance issuer node 140 (e.g., card issuing bank server) that privileges with an account should be halted/frozen (e.g., cancel card) or otherwise modified.

Although the authentication gateway node 100 is shown as being separate from the merchant node 120, in some embodiments the authentication gateway node 100 is incorporated into the credit/debit finance issuer node 140 or the merchant node 120 so that at least some of the operations disclosed herein as being performed by the authentication gateway node 100 are performed within the credit/debit finance issuer node 140 or the merchant node 120. Thus for example, the risk scores can be generated internal to the merchant node 120 and used to control when eCommerce authentication requests are communicated to the authentication node 130. The merchant node 120 can use the risk score to selectively send an eCommerce authentication request to the authentication node 130 for authentication of the purchaser when the risk score satisfies a defined rule or send the financial transaction to the acquirer node 122 and credit/debit finance issuer node 140 for verification against the cardholder's account without authentication of the purchaser by the authentication node 130 when the risk score does not satisfy a defined rule.

Similarly, although the authentication gateway node 100 is shown as being separate from the authentication node 130, in some embodiments the authentication gateway node 100 is incorporated into the authentication node 130 so that at least some of the operations disclosed herein as being performed by the authentication gateway node 100 are performed within the authentication node 130. Thus for example, the risk scores can be generated internal to the authentication node 130 and used to control which of the eCommerce authentication requests cause authentication challenges to be generated to purchasers.

The authentication response (e.g., 3-D Secure authentication response code) can be generated by the authentication node 130, based on authentication processes performed with the purchaser and/or may be generated by the authentication gateway node 100 based on the risk score (e.g., without authentication processing by the authentication node 130) and provided to the merchant node 120. The merchant node 120 receives the authentication response and may deny the transaction based on content of the authentication response (e.g., based on the risk score generated by the authentication gateway node 100 and/or based on the authentication processes by the authentication node 130 indicating failed authentication of the purchaser). When the transaction is not denied (e.g., risk score satisfies a defined rule or purchaser authentication completed), the merchant node 120 can initiate verification of the transaction by communicating to a credit/debit finance issuer node 140, via an acquirer node 122 (e.g., merchant's bank), the authentication response and content of the eCommerce authentication request (e.g., cardholder information, other content of an eCommerce authentication request disclosed herein, etc).

The acquirer node 122 routes the content of the eCommerce authentication request to a credit/debit finance issuer node 140 (e.g., card issuing bank server such as a Visa or other card server via VisaNet, BankNet, etc.), and may also send the authentication response. The credit/debit finance issuer node 140 generates an authorization decision based on whether the account number has a sufficient credit limit and/or existing funds to cover the amount of the financial transaction, and can further generate the authorization decision based on the authentication response from the authentication node 130 and/or the authentication gateway node 100.

The credit/debit finance issuer node 140 communicates its authorization decision to the acquirer node 122, which communicates an authorization decision to the merchant node 120. The merchant node 120 decides whether to complete the transaction with the purchaser or to deny the transaction based on the authorization decision from the acquirer node 122.

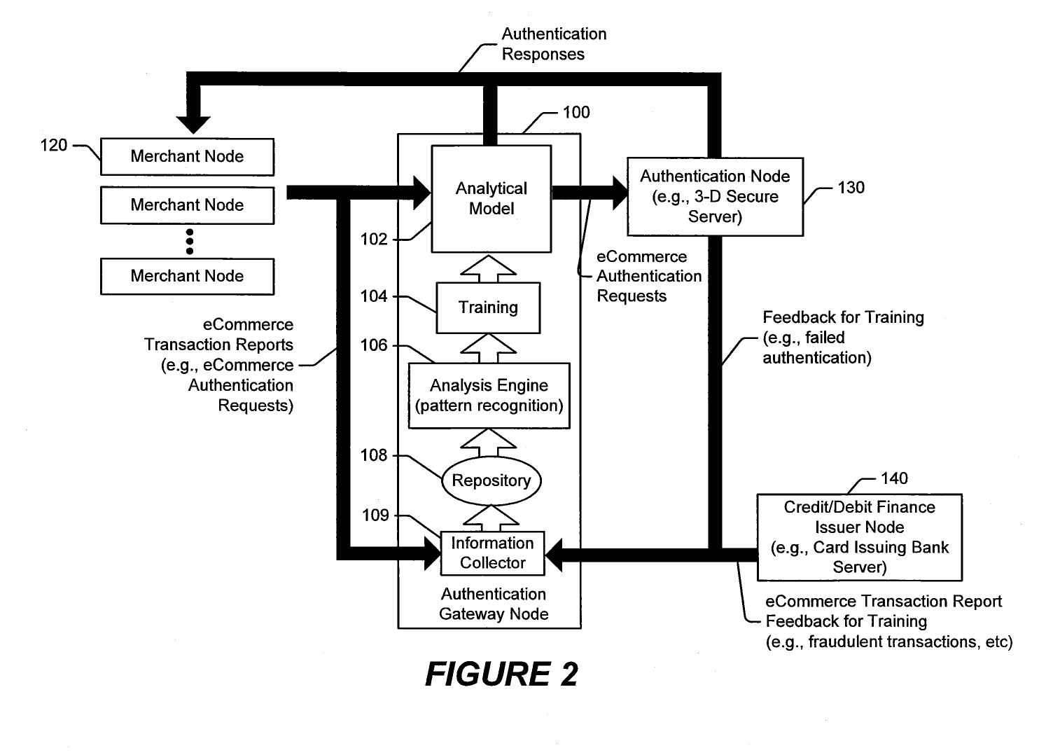

Further example operations by the authentication gateway node 100 are explained below with regard to FIGS. 2-5.

FIG. 2 is a block diagram illustrating further details of the financial transaction processing system of FIG. 1 that uses an authentication gateway node which contains an analytical model 102 of eCommerce transactions that generates risk scores which control selection of eCommerce authentication requests for authentication, and which may further be used to selectively trigger communication of credit/debit account warning messages to credit/debit finance issuer nodes 140. The analytical model 102 may be a non-linear analytical model, such as a neural network. When configured as a non-linear analytical model, the analytical model 102 has a non-linear relationship that allows different output values to be generated from a sequence of cycles of processing the same input values. Thus, repetitively processing the same eCommerce transaction value(s) through input(s) of the analytical model 102 can result in output of different corresponding risk scores as output values.

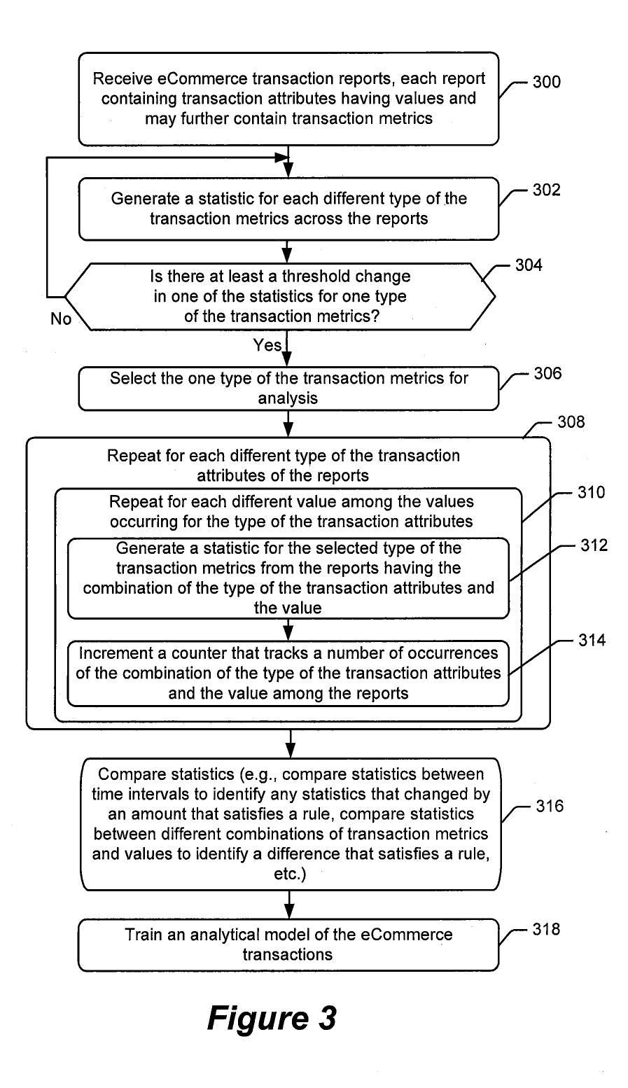

Referring to FIG. 2 and the operational flowchart of FIG. 3, the authentication gateway node 100 receives eCommerce transaction reports, e.g., eCommerce authentication requests, for pending eCommerce transactions from a plurality of merchant nodes 120. The authentication gateway node 100 processes content of each of the eCommerce authentication requests through an analytical model 102 to generate risk scores for the pending eCommerce transactions and selectively provides the eCommerce authentication requests to the authentication node 130 based on the risk scores.

The analytical model 102 is trained by a training circuit 104 (e.g., computer readable program code executed by a processor) based on eCommerce transaction reports received from the merchant nodes 120 (e.g., as eCommerce authentication requests) and/or based on eCommerce transaction reports received as feedback from finance issuer nodes 140 and/or other nodes of a financial transaction processing system.

The authentication gateway node 100 includes an information collector 109 that receives (block 300, FIG. 3) eCommerce transaction reports containing transaction attributes having values. Values of the transaction attributes can be generated based on the cardholder information received from the user terminal 100 and the merchant node 120, and may include transaction details, geo-location information, user terminal characteristics, and/or user account history information, etc and may include further sub-transaction attributes, such as the lettered sub-transaction attributes listed above in the context of reports that may be output by the merchant nodes 120.

In accordance with some embodiments disclosed herein, the eCommerce transaction reports received by the information collector 109 may include any one or more of the following transaction metrics:
1) Fraud metric;
2) Transaction abandonment metric;
3) Credential presentation failure metric;
4) Enrollment failure metric; and
5) Service or Transaction volume metric.

The fraud metrics may identify values of transaction attributes that occurred when fraud was detected. For example, when a cardholder reports to an credit issuer bank a fraudulent transaction in a particular eCommerce transaction, the bank may subsequently report to the information collector 109 values of the transaction attributes known for the eCommerce transaction along with a transaction metric for fraud with a value set to indicate that fraud was identified for those values of the transaction attributes. The credit issuer bank or another system node may also provide to the information collector 109 eCommerce transaction reports that identify fraud metrics where no fraud was identified and the associated values of transaction attributes that occurred without fraud.

The authentication node 130 may provide to the information collector 109 eCommerce transaction reports which contain transaction abandonment metrics and the values of the transaction attributes which occurred for the eCommerce transactions that were abandoned. The abandonment metrics indicate whether the authentication process was abandoned before completion of authentication of the purchaser. Thus, when an authentication process fails to complete due to a purchaser terminating a session before completion, an inactivity timer expiring without receiving a proper response from the purchaser, a software execution error by the user terminal 110, failure of a communication link to the user terminal 110, etc., values of the transaction attributes can be logged with an abandonment metric for reporting to the information collector 109.

The authentication node 130 may provide eCommerce transaction reports to the information collector 109 which contain credential presentation failure metrics and the associated values of the transaction attributes. The credential presentation failure metrics indicate whether the authentication process did not result in authentication of the purchaser due to, for example, the purchaser entering an incorrect security code more than a threshold number of times. Thus, when a purchaser fails to provide information satisfying authentication rules as part of authentication process, values of the transaction attributes can be logged with a credential presentation failure metric for reporting to the information collector 109.

The authentication node 130 and/or the credit/debit finance issuer node 140 may provide eCommerce transaction reports to the information collector 109 which contain enrollment failure metrics and the associated values of the transaction attributes. The enrollment failure metrics may, for example, indicate whether a cardholder was requested to enroll in an authorization program but has failed to complete enrollment within a threshold time, or has initiated an attempt to enroll in the authorization program but the information provided for the attempt was determined to be improper, insufficient, or to not satisfy a defined rule for allowing enrollment. Thus, when enrollment fails to occur, values of the transaction attributes can be logged with a enrollment failure metric for reporting to the information collector 109.

The authentication node 130 and/or the credit/debit finance issuer node 140 may provide eCommerce transaction reports to the information collector 109 which contain service or transaction volume metrics and the associated values of the transaction attributes. Alternatively or additionally, the authentication gateway node 100 may generate the service or transaction volume metrics based on eCommerce transaction reports, e.g., eCommerce authentication requests, received from the merchant nodes 120. The service or transaction volume metrics can indicate historical rates of occurrence of eCommerce transactions having defined values of transaction attributes. Thus, service or transaction volume metrics may be used to determine a rate at which eCommerce authentication requests having defined values of transaction attributes were generated from one or more defined merchant nodes 120, determine a rate of occurrence of the cardholder information being associated with merchant information in the eCommerce authentication requests in the repository (e.g., how frequently requests having the cardholder information have occurred with various ones of the merchant nodes 120), and/or determine patterns of transaction amounts, times of day, day of week, financial account numbers, frequency of transaction occurrence, location, and/or other content of the historical eCommerce transactions having matching attribute values. These patterns can be detected across any number of merchant nodes 120 and/or credit/debit finance issuer nodes 140.

The information collector 109 stores information from the reports in a repository 108. The repository 108 may additionally or alternatively reside at least partially within the merchant nodes 120 and/or another element of the financial transaction processing system.

An analysis engine 106 generates (block 302 of FIG. 3) a statistic for each different type of the transaction metrics across the eCommerce transaction reports, and determines (block 304) whether there is at least a threshold change in one of the statistics between two time intervals for one type of the transaction metrics. If so, that statistic is identified and that one type of the transaction metrics is selected (block 306) for analysis. Although the operations of FIG. 3 are described for ease of explanation in the context of a single type of the transaction metrics being selected (block 306), in some other embodiments more than one type of the transaction metrics is selected based on observing changes with those types of the transaction metrics.

For each combination of a different type of the transaction attributes of the reports (operational loop indicated by block 308) and a different value among the values occurring for the type of the transaction attributes (operational loop indicated by block 310), a statistic is generated (block 312) for the selected type of the transaction metrics from the reports, within a time interval, having the combination of the type of the transaction attributes and the value, and a counter is incremented (block 314) that tracks a number of occurrences of the combination of the type of the transaction attributes and the value among the reports. The statistic may be generated (block 312) based on numerically combining values for the selected type of the transaction metrics from the reports, within the time interval, which have (contain) the combination of the type of the transaction attributes and the value.

In the operational loops indicated by blocks 308 and 310, for each combination of a different type of the transaction attributes and a different value among the values occurring for the type of the transaction attribute, a statistic can be generated for the selected type of the transaction metrics from the reports having the combination of the type of the transaction attributes and the value.

A statistic may be generated by numerically combining (e.g., averaging) values of one of the types of the transaction metrics in all of the reports within a defined time interval or in only reports having a defined combination of one type of the transaction attribute and the value, which are received during one of the time intervals.

Generation of the statistic can include selecting a combination of one of the types of the transaction attributes from among the different types of the transaction attributes in the reports and one of the values from among the different values occurring for the one of the types of the transaction attributes. The operations can further include generating a combined statistic based on numerically combining the selected type of the transaction metrics from the reports, within the time interval, having the selected combination, and repeating the selecting a combination and the generating a combined statistic for other combinations of the types of the transaction attributes and the values among the reports within the time interval, where each of the combined statistics is associated with a different one of the combinations.

A statistic can thereby be generated (block 312) for transaction abandonment metrics (e.g., the selected (block 306) transaction metric for analysis) from all of the eCommerce transaction reports received within a defined timeframe that contain a defined set of transaction attributes having values. Thus each of the reports used to generate a first statistic can have common values for a set of transaction attributes, while the reports used to generate a second statistic can have common values for a set of transaction attributes which may be different than for the first statistic. In one particular illustrative example, statistics are separately determined for transactions associated with abandoned transaction (transaction abandonment metrics) having different combinations of types of transaction attributes and their values. For example, two transaction abandonment metric statistics can be separately generated for eCommerce transaction reports differing by only one value of one type of transaction attribute. The reports may therefore have the same credit card type, region of the country from which the transaction originated, and user terminal type, but differ by the eCommerce application version executed by the user terminal to provide the eCommerce transaction (e.g., on-line retailer application).

Thus, one transaction abandonment metric statistic may be generated (block 312) from values of the attributes of all of the eCommerce transaction reports received within the defined timeframe that have a transaction abandonment metric indicating abandonment and that contain transaction attributes having values for VISA credit cards having account numbers within a defined range and have eCommerce transactions that originate in a defined region of Canada from iPhone type user terminals executing an eCommerce application version X. Another transaction abandonment metric statistic may be generated (block 312) from values of the attributes of all of the eCommerce transaction reports received within the defined timeframe that have a transaction abandonment metric indicating abandonment and that contain transaction attributes having values for VISA credit cards having account numbers within the defined range and have eCommerce transactions that originate in the defined region of Canada from iPhone type user terminals executing an eCommerce application version Y, in contrast to the statistic above for eCommerce application version X. Accordingly, two statistics will be separately determined that are associated with transactions that were abandoned before completion of authentication. The statistics differ in their inputs by the version of the eCommerce application executed by the user terminal. Comparison of the statistics may identify a significantly higher transaction failure rate with application version X compared to application version Y, which may, in turn, indicate that a problem exists with the application version X. A notification may be generated to an owner of the eCommerce application identifying the problem.

The previous example may similarly be repeated to determine statics related for fraud metrics. Comparison of the statistics may identify that application version X has a significantly higher reported transaction fraud rate compared to application version Y, which may, in turn, indicate that a fraud problem exists with the application version X due to, for example, insufficient security mechanisms provided in application version X.

The analysis engine 109 compares (block 316) the statistics that were generated (block 312). For example, each of the statistics generated for a combination of a type of the transaction attributes and a value can be compared (block 316) between two time intervals, e.g., a present time interval and a previous time interval, to determine whether the statistic changed by an amount that satisfies a defined rule.

Alternatively or additionally, the statistics generated (block 312) for the various combinations are compared (block 316) to each other for a same time interval. Thus, for example, a transaction abandonment statistic for one combination of a type of the transaction attributes and a value which is a threshold amount above the average transaction abandonment statistic for the other combinations of the types of the transaction attributes and values can be flagged to identify an underlying basis for why that transaction abandonment statistic is higher. A particular set of user terminal characteristics or a geographical location may be identified as a likely cause of the higher transaction abandonment statistic, such as due to a computer processing problem or a regional network failure problem, respectively.

For example, the comparison (block 316) performed by the analysis engine 106 may identify a combination of one or more types of transaction attributes and one or more values that have a risk of resulting in a fraudulent transaction, a credential presentation failure, or one or more other ones of the transaction metrics that satisfies a defined rule.

Output of the analysis engine 109 can be used by a training circuit 104 (e.g., computer readable program code executed by a processor) to train (block 318 of FIG. 3) the analytical model 102 of the eCommerce transactions to identify occurrence of defined combinations of the types of transaction metrics and values. The analytical model 102 may be a non-linear model such as a neural network model. The training circuitry 104 can train the neural network model 102 with content of the historical eCommerce transaction reports and/or based on eCommerce authentication requests or other eCommerce transaction data received from merchant nodes 120 or other nodes within the system.

Some or all of the processes of FIG. 3 can be performed in real-time as eCommerce transaction reports are received from any one or more of the nodes within the system. For example, the processes of FIG. 3 can generate statistics based on streams of eCommerce transaction reports, e.g., eCommerce authentication requests, received from the merchant nodes 120 and/or based on real-time feedback from the authentication nodes 130 and/or the credit/debit finance issuer nodes 140. The processes may be repeated at a defined iteration rate to process batches of variable numbers of, for example, eCommerce authentication requests from the merchant nodes 120 during each time interval. Alternatively, the processes may be repeated at variable rates defined based on the rate of receipt of the eCommerce authentication requests, such as by triggering execution of the processes responsive to a threshold number of the eCommerce authentication requests temporarily stored in an input buffer awaiting processing. In some other embodiments the processes of FIG. 3 are performed off-line.

Training an analytical model 102 can be performed based on the values of the transaction attributes for the transaction metric statistics (block 312) for the selected type of the transaction metrics and based on the counters (block 314) that track a number of occurrences of the combination of the type of the transaction attribute and the value among the reports.

Which of the eCommerce transaction reports are used to train the analytical model 102 can be selected based on the comparison (block 316). For example, when the comparison (block 316) identifies that observed anomalies in one of the transaction metrics (e.g., credential presentation failure) is due to a user terminal compatibility issue or other technical problem, the eCommerce transaction reports having the combination of type of transaction metrics and values associated with the anomaly may not be selected for use in training the analytical model 102. In contrast, when the comparison (block 316) identifies that observed anomalies in one of the transaction metrics (e.g., credential presentation failure) is due to the user entering a threshold number of improper password codes responsive to an authentication challenge, the eCommerce transaction reports having the combination of type of transaction metrics and values associated with the user's terminal, location, etc., may be selected for use in training the analytical model 102.

The analytical model (102, FIG. 2) can be trained based on any of the statistics associated with the different combinations of types of transaction attributes and values that satisfy one or more defined rules. For example, when the comparison identifies a statistic for one combination of a type of the transaction attributes having a value that satisfies a defined rule (e.g., increased at least a threshold amount between two time intervals), the transaction attribute having the value may be used to train the analytical model 102 to be able to identify any future occurrence of the type of the transaction attributes having the value in an eCommerce transaction report, e.g., eCommerce authentication request, received from merchant nodes 120.

The training circuitry 104 may furthermore dynamically train (e.g., fine-tune) the analytical model 102 responsive to content of eCommerce transaction reports, e.g., eCommerce authentication requests, that are dynamically received from merchant nodes 120. The information collector 109 may receive eCommerce authentication requests from the merchant nodes 120 and may further receive authentication responses from the authentication node 130 indicating whether authentication of identified ones of the eCommerce authentication requests passed or failed the authentication process. The information collector 109 stores the transaction information and any feedback in the repository 108. The comparison engine 106 may identify patterns or other similarities in the transaction information that are associated with a matching user terminal identifier. The training circuitry 104 can use the identified patterns to or dynamically train the analytical model 102 based on recently occurring eCommerce transactions.

As explained above, content of a eCommerce transaction report, e.g., eCommerce authentication request, of a pending eCommerce transaction is processed through the analytical model 102 to generate the risk score. Referring to the operations of FIG. 4, the authentication gateway node 100 receives (block 400) from a merchant node 120 an eCommerce authentication request for a pending eCommerce transaction associated with a user terminal 110. The eCommerce authentication request contains transaction attributes having values for a pending eCommerce transaction. The authentication gateway node 100 processes (block 402) content of the eCommerce authentication request through the analytical model 102 to generate a risk score. The eCommerce authentication request is then selectively provided (block 404) to the authentication node 130 based on the risk score.

The risk score may be generated based on a level of similarity between values of the transaction attributes contained in the eCommerce authentication request and values of the corresponding transaction attributes modeled by the analytical model 102. For example, when the analytical model 102 is a neural network model, values of the transaction attributes contained in the eCommerce authentication request can be provided to input nodes of the neural network for propagation thereto to output weighted output values that are combined to generate a numerical risk score for the eCommerce authentication request.

The analytical model 102 may, for example, receive hundreds or thousands of simultaneously occurring or nearly simultaneously occurring eCommerce authentication request from tens, hundreds, or thousands of different merchant nodes 120, and generate risk scores that are used to determine which of the eCommerce authentication requests will be processed by the authentication node 130 to authenticate associated purchasers (or other persons) associated with the eCommerce authentication requests and/or to selectively communicate credit/debit account warning messages.

The analytical model 102 may be trained to identify when eCommerce authentication requests have one or more of the following characteristics:
1) associated with a same user terminal 110 and occurring at a rate that is greater than an expected rate arising from user terminals, which may indicate that eCommerce purchases are being electronically generated by a possibly malicious program instead of by a human purchaser;
2) associated with a same merchant node 120 and occurring at a rate that is outside an expected range (e.g., greater than a historical observed upper rate from the merchant node 120 and/or other merchant nodes having similar characteristics as the merchant node 120 for a particular time of day and/or day or week/year);
3) arising from a same geographic region, such as geographic region of the user terminal 110, the merchant node 120, the acquirer node 122, and/or the credit/debit finance issuer node 140, and occurring at a rate that is outside an expected range (e.g., greater than a historical observed upper rate for a particular time of day and/or day or week/year); and
4) generated by the acquirer node 122 at a rate that is outside an expected range (e.g., greater than a historical observed upper rate from the acquirer node 122 for a particular time of day and/or day or week/year).

Thus, for example, a credit card that has been used to make similar purchase amounts at a high rate of occurrence with a plurality of merchant nodes 120 may be deemed a high risk for fraudulent activity based on a defined rule. The authentication gateway node 100 can therefore operate through the analytical model 102 to generate risk scores that cause eCommerce authentication requests associated with the credit card to be authenticated by the authentication node 130. Furthermore, the authentication gateway node 100 may determine from mining information content in the repository 108 that one or more other credit cards should also be subject to authentication. The authentication gateway node 100 can therefore decide to generate risk scores that cause eCommerce authentication requests associated with any of the one or more other credit cards to be authenticated by the authentication node 130.

In another embodiment, the authentication gateway node 100 generates the risk score for the received eCommerce authentication request based on a rate at which eCommerce authentication requests were generated from one or more defined merchant nodes 120. For example, when eCommerce authentication requests from a merchant node 120 have occurred at a rate that indicates likely/possible fraudulent transactions (e.g., the merchant node is operating fraudulently and/or is being subjected to financial transaction requests from a user terminal(s) operating fraudulently), the authentication gateway node 100 can use content of the repository to identify one or more other merchant nodes 120 that are predicted to be subjected to likely/possible fraudulent transactions, and can cause authentication to be performed for eCommerce authentication requests from the one or more other merchant nodes 120. The authentication gateway node 100 may identify the one or more other merchant nodes 120 based on comparing content of eCommerce authentication requests for the likely/possible fraudulent transactions to content of the repository similarities and patterns there between.

In another embodiment, the authentication gateway node 100 generates the risk score for the received eCommerce authentication request based on a rate of occurrence of the cardholder information being associated with merchant information in the eCommerce authentication requests in the repository 108 (e.g., how frequently requests having the cardholder information have occurred with various ones of the merchant nodes 120). The authentication gateway node 100 may generate the risk score to cause authentication of the purchaser to be performed when the rate is outside an expected range, such as being greater than a historical observed upper rate for a particular time of day and/or day or week/year, and/or when the rate is indicative of transactions against the cardholder information and/or directed to merchant information being electronically generated by a possibly malicious program instead of a human purchaser.

Controlling which eCommerce authentication requests are provided to the authentication node 130 based on the risk scores can effectively prioritize authenticating only the eCommerce authentication requests that appear to have a greater risk of originating from purchasers who are not the account owner or otherwise authorized by the account owner for the purchase. The other eCommerce authentication requests can bypass authentication by the authentication node 130, allowing verification by a credit/debit finance issuer node 140 (e.g., card issuing bank server such as a Visa or MasterCard member bank server) to proceed. Because some, and perhaps most, eCommerce authentication requests are not authenticated by the authentication node 130, e.g., depending upon a rule defining which risk scores cause authentication, merchants can have substantially lower transaction costs (e.g., reduced per-transaction purchaser authentication fees by a reduced number of authenticated transactions) and fewer transaction abandonments due to fewer purchasers being challenged to complete authentication processes.

### Example Risk Assessment Computer System

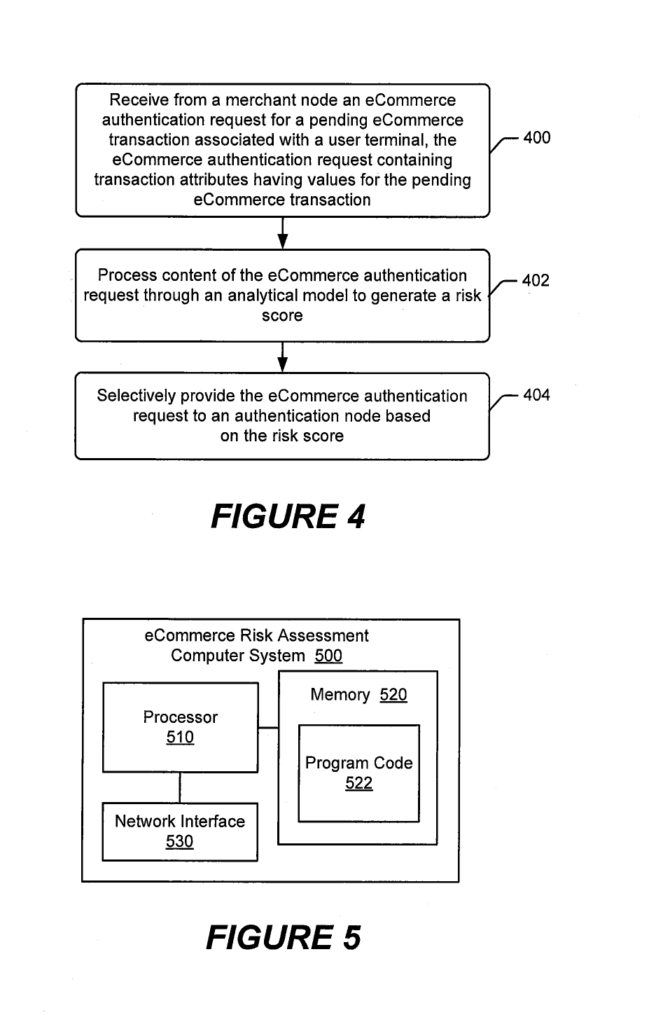

FIG. 5 is a block diagram of a eCommerce risk assessment computer system 500 that may be used in the authentication gateway node 100 when configured according to some embodiments of the present disclosure. The eCommerce risk assessment computer system 500 includes a processor 510, a memory 520, and a network interface 530 which may include a radio access transceiver and/or a wired network interface (e.g., Ethernet interface). The processor 510 may include one or more data processing circuits, such as a general purpose and/or special purpose processor (e.g., microprocessor and/or digital signal processor) that may be collocated or distributed across one or more networks. The processor 510 is configured to execute computer program code 522 in the memory 520, described below as a non-transitory computer readable medium, to perform at least some of the operations described herein as being performed by an authentication gateway node. The computer program code when executed by the processor 510 causes the processor 500 to perform operations in accordance with one or more embodiments disclosed herein for the authentication gateway node 100. The eCommerce risk assessment computer system 500 may further include a user input interface (e.g., touch screen, keyboard, keypad, etc.), a display device, mass data storage (e.g., for storage of the repository 108 and/or the analytical model 102), etc.

### FURTHER DEFINITIONS AND EMBODIMENTS

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A computer program product, comprising:
a non-transitory computer readable storage medium comprising computer readable program code embodied in the medium that when executed by a processor of an application analysis computer causes the processor to perform operations comprising:
receiving eCommerce transaction reports, each of the reports containing transaction metrics and transaction attributes having values;
generating a statistic separately for each different type of the transaction metrics across the reports based on the values of the transaction attributes;
identifying one of the statistics, for one type of the transaction metrics, that has changed at least a threshold amount between two time intervals;
selecting the one type of the transaction metrics for analysis;
for each combination of a different type of the transaction attributes and a different value among the values occurring for the type of the transaction attribute,
generating a transaction metric statistic for the selected type of the transaction metrics from the reports, within a time interval, having the combination of the type of the transaction attribute and the value, and
incrementing a counter that tracks a number of occurrences of the combination of the type of the transaction attribute and the value among the reports;
training an analytical model of the eCommerce transactions based on the values of the transaction attributes for the transaction metric statistics for the selected type of the transaction metrics and based on the counters that track a number of occurrences of the combination of the type of the transaction attribute and the value among the reports; and
outputting risk scores from the analytical model based on content of eCommerce transactions that are input to the analytical model.

2. The computer program product of claim 1, wherein the generating a statistic separately for each different type of the transaction metrics across the reports based on the values of the transaction attributes, comprises:
separately generating statistics for different ones of the transaction metrics comprising at least two of a fraud metric, a transaction abandonment metric, a credential presentation failure metric, an enrollment failure metric, and a service or transaction volume metric.

3. The computer program product of claim 1, wherein the different types of the transaction attributes comprise at least two of eCommerce transaction details, geo-location information for a user terminal of a person who is associated with the eCommerce authentication request, characteristics of the user terminal, and user account history.

4. The computer program product of claim 1, wherein:
one of the types of the transaction attributes for a pending eCommerce transaction is transaction details that comprises an account number for a credit card, a cardholder's name, a cardholder's home address, and an amount of an eCommerce transaction; and
the outputting risk scores from the analytical model based on content of eCommerce transactions that are input to the analytical model, comprises generating the risk score for the pending eCommerce transaction based on similarities between values of the transaction attributes and values of transaction attributes modeled by the analytical model.

5. The computer program product of claim 1,
wherein the outputting risk scores from the analytical model based on content of eCommerce transactions that are input to the analytical model, comprises:
receiving from a merchant node an eCommerce authentication request for a pending eCommerce transaction associated with a user terminal operated by a person, the eCommerce authentication request containing transaction attributes having values characterizing the pending eCommerce transaction; and
generating a risk score for the pending eCommerce transaction based on similarities between the values of the transaction attributes from the eCommerce authentication request and values of transaction attributes modeled by the analytical model; and
further comprising selectively providing the eCommerce authentication request to an authentication node based on the risk score.

6. The computer program product of claim 5, wherein the selectively providing the eCommerce authentication request to an authentication node based on the risk score, comprises:
selectively marking the eCommerce authentication request to indicate whether authentication of the person who is associated with the eCommerce authentication request, by the authentication node is requested based on whether the risk score satisfies a defined rule.

7. The computer program product of claim 5, wherein the selectively providing the eCommerce authentication request to an authentication node based on the risk score, comprises:
selectively routing the eCommerce authentication request to the authentication node for authentication of the person who is associated with the eCommerce authentication request, based on whether the risk score satisfies a defined rule.

8. The computer program product of claim 5, further comprising:
selectively generating an authentication challenge to the user terminal of the person who is associated with the eCommerce authentication request, based on whether the risk score satisfies a defined rule.

9. The computer program product of claim 1, further comprising:
for each of the transaction metric statistics, comparing the transaction metric statistic between two time intervals to identify whether the transaction metric statistic has changed a threshold amount; and
selectively using the values of the transaction attributes for any one of the transaction metric statistics to train the analytical model based on whether the one of the transaction metric statistics was identified as having changed the threshold amount.

10. The computer program product of claim 9, wherein the one of the two time intervals is a present time interval and the other one of the two time intervals immediately precedes the present time interval.

11. The computer program product of claim 1, further comprising:
selectively using the values of the transaction attributes for any one of the transaction metric statistics to train the analytical model based on whether comparison of the one of the transaction metric statistics to other ones of the transaction metric statistics satisfies a defined rule.

12. The computer program product of claim 1, wherein the training an analytical model of the eCommerce transactions based on the values of the transaction attributes for the transaction metric statistics for the selected type of the transaction metrics and based on the counters that track a number of occurrences of the combination of the type of the transaction attribute and the value among the reports, comprises.
training a neural network model of the eCommerce transactions based on the values of the transaction attributes for the transaction metric statistics for the selected type of the transaction metrics.

13. A method comprising:
performing operations as follows on a processor of an eCommerce risk assessment computer system:
receiving eCommerce transaction reports, each of the reports containing transaction metrics and transaction attributes having values;
generating a statistic separately for each different type of the transaction metrics across the reports based on the values of the transaction attributes;
identifying one of the statistics, for one type of the transaction metrics, that has changed at least a threshold amount between two time intervals;
selecting the one type of the transaction metrics for analysis;
for each combination of a different type of the transaction attributes and a different value among the values occurring for the type of the transaction attribute,
generating a transaction metric statistic for the selected type of the transaction metrics from the reports, within a time interval, having the combination of the type of the transaction attribute and the value, and
incrementing a counter that tracks a number of occurrences of the combination of the type of the transaction attribute and the value among the reports;
training an analytical model of the eCommerce transactions based on the values of the transaction attributes for the transaction metric statistics for the selected type of the transaction metrics and based on the counters that track a number of occurrences of the combination of the type of the transaction attribute and the value among the reports; and
outputting risk scores from the analytical model based on content of eCommerce transactions that are input to the analytical model.

14. The method of claim 13, wherein:
one of the types of the transaction attributes for a pending eCommerce transaction is transaction details that comprises an account number for a credit card, a cardholder's name, a cardholder's home address, and an amount of an eCommerce transaction; and
the outputting risk scores from the analytical model based on content of eCommerce transactions that are input to the analytical model, comprises generating the risk score for the pending eCommerce transaction based on similarities between values of the transaction attributes and values of transaction attributes modeled by the analytical model.

15. The method of claim 13,
wherein the outputting risk scores from the analytical model based on content of eCommerce transactions that are input to the analytical model, comprises:
receiving from a merchant node an eCommerce authentication request for a pending eCommerce transaction associated with a user terminal operated by a person, the eCommerce authentication request containing transaction attributes having values characterizing the pending eCommerce transaction; and
generating a risk score for the pending eCommerce transaction based on similarities between the values of the transaction attributes from the eCommerce authentication request and values of transaction attributes modeled by the analytical model; and
further comprising selectively providing the eCommerce authentication request to an authentication node based on the risk score.

16. The method of claim 15, wherein the selectively providing the eCommerce authentication request to an authentication node based on the risk score, comprises:
selectively marking the eCommerce authentication request to indicate whether authentication of the person who is associated with the eCommerce authentication request, by the authentication node is requested based on whether the risk score satisfies a defined rule.

17. The method of claim 15, wherein the selectively providing the eCommerce authentication request to an authentication node based on the risk score, comprises:
selectively routing the eCommerce authentication request to the authentication node for authentication of the person who is associated with the eCommerce authentication request, based on whether the risk score satisfies a defined rule.

18. The method of claim 15, further comprising:
selectively generating an authentication challenge to the user terminal of the person who is associated with the eCommerce authentication request, based on whether the risk score satisfies a defined rule.

19. The method of claim 13, further comprising:
for each of the transaction metric statistics, comparing the transaction metric statistic between two time intervals to identify whether the transaction metric statistic has changed a threshold amount; and
selectively using the values of the transaction attributes for any one of the transaction metric statistics to train the analytical model based on whether the one of the transaction metric statistics was identified as having changed the threshold amount.

20. The method of claim 13, further comprising:
selectively using the values of the transaction attributes for any one of the transaction metric statistics to train the analytical model based on whether comparison of the one of the transaction metric statistics to other ones of the transaction metric statistics satisfies a defined rule.
